(19) United States
(12) Patent Application Publication
(10) Pub. No.: US 2011/0029315 A1
(43) Pub. Date: Feb. 3, 2011

(54) VOICE DIRECTED SYSTEM AND METHOD FOR MESSAGING TO MULTIPLE RECIPIENTS

(76) Inventors: Brent Nichols, Greensburg, PA (US); Jeff Pike, Murrysville, PA (US); Mark Mellott, Pittsburgh, PA (US); Dave Findlay, Freeport, PA (US); James R. Logan, Pittsburgh, PA (US)

Correspondence Address: WOOD, HERRON & EVANS, LLP, 2700 CAREW TOWER, 441 VINE STREET, CINCINNATI, OH, 45202, US

(21) Appl. No.: 12/845,005

(22) Filed: Jul. 28, 2010

Related U.S. Application Data
(60) Provisional application No. 61/229,080, filed on Jul. 28, 2009.

(51) Int. Cl. G10L 21/00

(52) U.S. Cl. 704/275; 704/E11.001

(57) ABSTRACT

A method for sending messages in a voice-enabled system and a voice-enabled system to communicate a message are provided. The method comprises generating a message with a message generating device, analyzing the message to determine a voice-enabled device to send the message, and determining whether the voice-enabled device is available to receive the message. The method further comprises sending the message to the voice-enabled device in response to determining that the voice-enabled device is available to receive the message and, in response to determining that the voice-enabled device is not available, escalating the message based on an escalation protocol.

### CROSS REFERENCE TO RELATED APPLICATION

This application claims priority to U.S. Patent Application Ser. No. 61/229,080 to Brent Nichols et al. entitled “VOICE DIRECTED SYSTEM AND METHOD FOR MESSAGING TO MULTIPLE RECIPIENTS” and filed on Jul. 28, 2009, which is incorporated by reference herein in its entirety.

### FIELD OF THE INVENTION

In a general sense the present invention concerns a wireless voice-enabled communication method and system having the capability of sending and managing messages to selected recipients.

### BACKGROUND OF THE INVENTION

Speech recognition has simplified many tasks in the workplace by permitting hands-free communication with a computer as a convenient alternative to communication via conventional peripheral input/output devices. A worker may enter commands and data by voice using speech recognition and commands or instructions may be communicated to the worker using speech synthesis. Speech recognition finds particular application in mobile computing devices in which interaction with a computer by conventional peripheral input/output devices is restricted.

For example, wireless wearable devices can provide a worker performing work-related tasks with desirable informational and data processing functions while offering the worker enhanced mobility within the workplace. With respect to utilizing voice technology with wearable devices, the actual utilization of voice can take various forms. In one aspect, voice technology might be implemented to assist a user in performing their various tasks. In such a case, voice is used to retrieve information about work-related tasks, as well as other data, on an as-needed basis. Such voice assistance, for example, is provided in the ACCUNURSE® product available from Vocollect Healthcare Systems, Inc. of Pittsburgh, Pa. Alternatively, voice might be used in a more forceful way to specifically direct a user through their work tasks. For example, in warehouse and inventory management systems, workers are told to go to specific locations and retrieve or place certain quantities of specific items. One example of such a voice-directed system is the TALKMAN® system available from Vocollect, Inc. of Pittsburgh, Pa.

Such voice systems generally rely upon computerized central management systems for managing information and tracking and assigning the various diverse tasks that a user or worker might perform in their workday. An overall integrated voice system involves a combination of a central computer or server system, the people who use and interface with the computer system using voice (“users”) and the portable voice devices that the users wear or carry. The users handle various work tasks using voice under the assistance and command/control of information and data transmitted from the central system to the wireless wearable device that is voice enabled. As the workers complete their tasks, a bi-directional communication stream of information is exchanged over a wireless network between the wearable devices and the central system. Information received by each wearable device from the central system is translated into voice instructions or data for the corresponding user. Typically, the user wears a headset that has a microphone for voice data entry and an ear speaker for audio output feedback from the central system. The headset might be a stand-alone device or might be implemented or connected/coupled with a portable or wearable computer device. Input speech from the user is captured by the headset and communicated to the central computer system. Using the headset and other devices, for example, workers may pose questions, report the progress in accomplishing their assigned tasks, report working conditions and receive information. Using such wireless voice devices, users perform assigned tasks and gather information virtually hands-free without equipment to juggle or paperwork to carry around. Because manual data entry is eliminated or reduced, workers can perform their tasks faster, more accurately, and more productively.

Generally, in a voice system, a user signs into the system or “logs on” to the central system to let the central system know that they are working or are accessible through their voice device. Once a user is signed in, they can obtain information regarding their work tasks. The central system tracks who is signed in, and thus, who is available in the overall system. As may be appreciated, the specific voice communications and dialog exchanged between the users and the central system can be very task-specific and highly variable. Two such examples for utilizing voice in the work environment are in the healthcare industry and warehousing/inventory industries, as noted in the voice products mentioned above.

In addition to the individual communication links to each user, the capability to handle messages for a number of different users is also beneficial. Messaging provides the ability, in a voice-enabled system, to interject important messages into the speech dialog. For example, U.S. patent application Ser. No. 11/057,537, entitled “Voice-Directed System and Method Configured for Assured Messaging to Multiple Recipients”, filed on Feb. 14, 2005, provides one particular voice-based messaging system for handling messages that are sent out to multiple users. Another message capability is provided by the system of U.S. Patent Application No. 61/087,082, entitled “Voice Assistant System”, filed on Aug. 7, 2008. These applications are incorporated herein by reference in their entirety.

Despite such systems handling messaging to multiple users within a voice-based system, there is still a need to improve upon messaging handling to both ensure that the necessary recipients receive the message, or if such recipients are not available, to ensure proper disposition of the message and the works or tasks associated therewith. Furthermore, there is a need for ensuring that information associated with a message is properly handled and that the information is not lost due to initial delays in properly handling such messages and responding thereto.

### SUMMARY

Embodiments of the invention provide a method for sending messages in a voice-enabled system and a voice-enabled system to communicate a message. In specific embodiments, the method comprises generating a message with a message generating device, analyzing the message to determine a voice-enabled device to send the message, and determining whether the voice-enabled device is available to receive the message. The method further comprises sending the message to the voice-enabled device in response to determining that the voice-enabled device is available to receive the message and, in response to determining that the voice-enabled device is not available, escalating the message based on an escalation protocol.

In alternative embodiments, the voice-enabled system includes a message generating component configured to generate a message and a computing system. The computing system is configured to analyze the message to determine a voice-enabled device to which to send the message, and determine whether the voice-enabled device is available to receive the message. The computing system is further configured to send the message to the voice-enabled device in response to determining that the voice-enabled device is available to receive the message and escalate the message based on an escalation protocol in response to determining that the voice-enabled device is not available to receive the message.

### BRIEF DESCRIPTION OF THE DRAWINGS

The accompanying drawings, which are incorporated in and constitute a part of this specification, illustrate embodiments of the invention and, together with the detailed description of the embodiments given below, serve to explain the principles of the invention.

FIG. 1 illustrates an exemplary environment in which wireless devices operate in accordance with the principles of the present invention.

FIG. 2 depicts an exemplary computer platform that supports a system manager or server in accordance with the principles of the present invention.

FIG. 3 depicts a flowchart of an exemplary method of handling messages to multiple wireless recipients in accordance with the principles of the present invention.

### DETAILED DESCRIPTION OF SPECIFIC EMBODIMENTS OF THE INVENTION

Embodiments of the present invention relate to a wireless communication system that include a central computer or server (“central system”) communicating over a wireless network with a plurality of wireless user devices. The central computer can receive a message via input devices (e.g., a wireless user device, a mouse, a keyboard, etc.) and then transmit the message to selected wireless user devices. At the user device, any text is converted to an audio signal that is output via a speaker to be heard by a user. Alternatively, a recorded voice message might be replayed in its original audio form. In response to receiving a message, a user can access the message, play or hear the message, and otherwise handle the message or respond thereto. The central system is able to track and handle delivery of the message to each of the intended recipients. The central system, in one aspect of the invention, is also able to handle situations where the desired recipient does not receive or does not access a message.

In a general sense, one aspect the present invention concerns a wireless voice-enabled system having central computer/server and a plurality of client devices that typically are worn by or associated with individual users (user devices). The user devices are voice or speech-enabled and have speech recognition capability, including text-to-speech conversion capability. The system is configured such that the central computer sends a message to one or more users in a group of users. The devices of the selected users receive the message and play the message or convert it to synthesized speech to be heard by the user. Generally, the message is heard only by the associated predetermined user or group of users and is silent to all other persons in the voice-enabled working environment. One aspect of the invention is that it has the capability of assuring that the message is properly handled or heard before it is discarded.

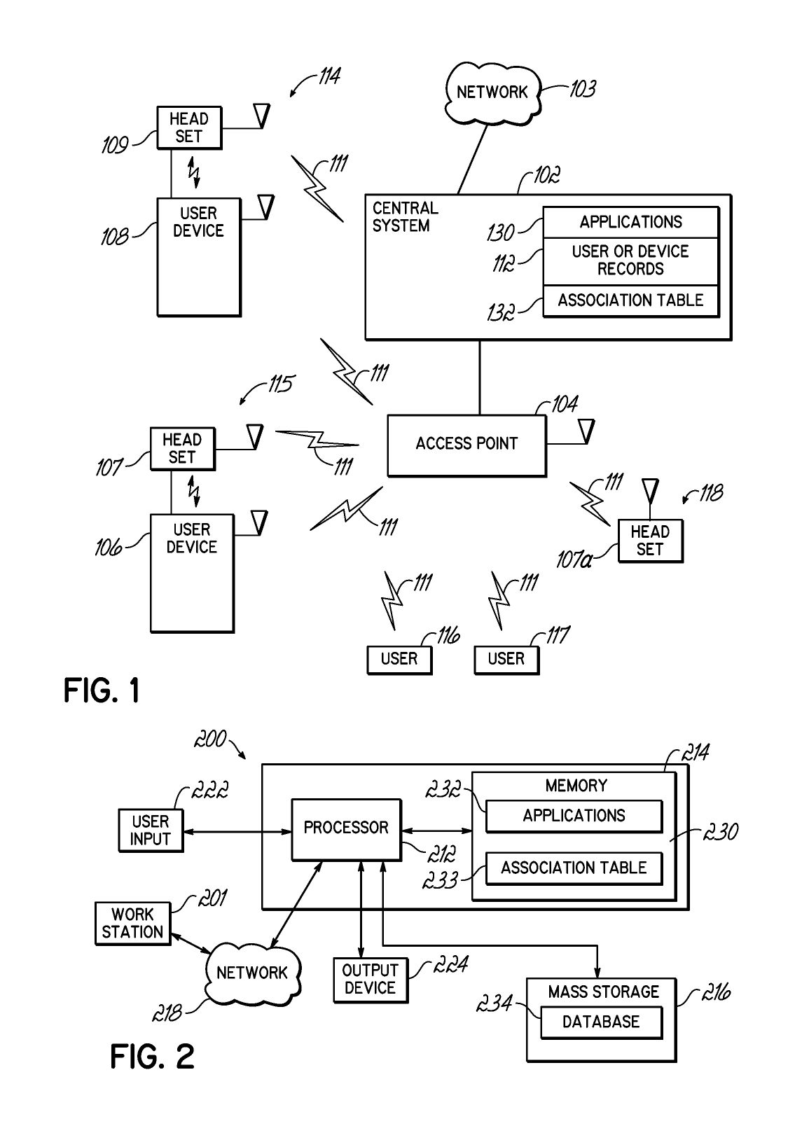

FIG. 1 illustrates an exemplary environment utilizing wireless devices and headsets in accordance with principles of the present invention. In an exemplary use, a pair of wireless headsets and devices are used by different users or operators to communicate with a central system. The central system is able to send messages to a user device, which plays the message for the recipient user. Any speech input from the user regarding the message is generated at the headset and may be transmitted to the central system either directly or through the device. The link between the devices and the central system may be a typical wireless network or WLAN. The link between the user devices and the respective headsets is typically a cable or wire. In alternative embodiments, the headsets and devices may be coupled together via a wireless connection. Furthermore, the functionality of the user device may be fully implemented in just the headset, so that a user just wears a headset and does not carry another separate device.

The central system 102 may include a conventional computer system or server that can run a variety of applications 130. These applications may, for example, relate to the healthcare of patients or residents in a healthcare or assisted-living facility, or might be directed to maintaining and handling inventory for a warehouse. The central system will also include one or more applications that relate to controlling the messaging and communications with the different devices.

The central system may take any suitable form and may include or one more computer or server devices. Furthermore, central system 102 might be incorporated with another outside network 103, such as the Internet, to couple with other systems or devices. Accordingly, the present invention is not limited to the exemplary embodiment illustrated in the block diagram of FIG. 1, but might include other devices for providing the necessary interconnectivity for delivering messages to one or more users. The application that manages the wireless user devices carried or worn by the users maintains information about the identification of each device so that messages can be directed to a desired device and information received from the device at the system 102 can be traced to the sending device. System 102 would maintain, for example, a table of the addresses for each device and their association with a particular user system 102 uses these addresses to identify a sender or recipient of a particular message.

In the exemplary environment of FIG. 1, the system 102 is coupled with one or more access points 104 which are distributed throughout an area serviced by a wireless network. Various wireless network technologies are currently available for implementation of the invention.

Each user within the environment of FIG. 1 carries or wears a wireless device for sending and receiving messages, such as a wireless device 106, 108 and/or an associated headset 107, 109. As noted above, the user devices might include a headset 107 that provides the necessary audio speaker and microphone for voice communications in the voice system. In existing systems, headset 107 is worn on the head of the user, while the other user device 106 is carried or worn by the user, such as on their belt. Headset 107 might be coupled in a wired fashion or wirelessly to device 106. In such a scenario, the user device 106 would generally maintain the wireless link 111 with the access point 104 and central system 102. Also, device 106 might run various speech recognition applications utilized in a speech-enabled work environment.

Alternatively, a headset device 107 might incorporate the full functionality of a separate user device 106 including wireless communication capability with central system 102 as well as the speech-recognition functionality. Therefore, the exemplary embodiments are not limiting with respect to the user devices carried or worn by the user and implementing the invention. Generally, because the invention is implemented within a speech-enabled environment to handle voice messages and the hands-free handling of such messages utilizing voice commands, the wireless user devices will minimally incorporate the necessary functionality such as a speaker for playing an audio message to a user and a microphone for capturing the speech of the user. In FIG. 1, reference numerals 114, 115, 116, 117, and 118 are utilized to indicate multiple users in the system, which can serve any number of users even though a limited number are shown in the exemplary embodiment of FIG. 1.

To aid in monitoring the users 114-118 and their devices, the system 102 may maintain record information 112 about which user is signed on to what wireless device as well as address information 132 that associates a network address (e.g., an IP address) with a particular device, and, therefore with a particular user.

FIG. 2 illustrates an exemplary hardware and software environment for the central server/computer system 200 suitable for implementing in the invention. For the purposes of the invention, the computer system 200 may represent practically any type of computer, computer system or other programmable electronic device, including a client computer, a server computer, a portable computer, a handheld computer, an embedded controller, etc. Moreover, the computer system 200 may be implemented using one or more networked computers, e.g., in a cluster or other distributed computing system.

Computer system 200 typically includes at least one processor 212 coupled to a memory 214. Processor 212 may represent one or more processors (e.g., microprocessors), and memory 214 may represent the random access memory (RAM) devices comprising the main storage of computer 200, as well as any supplemental levels of memory, (e.g., cache memories, non-volatile or backup memories read-only memories, etc.) In addition, memory 214 may be considered to include memory storage physically located elsewhere in computer 200, as well as any storage capacity used as a virtual memory, such as stored on a mass storage device 216 or on another computer or device coupled to computer 200 via the Internet 218 or some other network (not shown).

For additional storage, computer 200 may also include one or more mass storage devices 216, (e.g., a floppy or other removable disk drive, a hard disk drive, a direct access storage device (DASD), an optical drive, a CD drive, a DVD drive, etc., and/or a tape drive, among others.) Furthermore, computer 200 may include an interface with one or more networks 218 (e.g., a LAN, a WAN, a wireless network, and/or the Internet, among others) to permit the communication of information with other computers and devices coupled to the network. It should be appreciated that computer 200 typically includes suitable analog and/or digital interfaces between processor 212 and each of components 214, 216, 218, 222 and 224 as is well known in the art.

Computer system 200 typically receives a number of inputs and outputs for communicating information externally. For interfacing with a user or operator, computer system 200 typically includes one or more user input devices 222 (e.g., a keyboard, a mouse, a trackball, a joystick, a touchpad, and/or a microphone, among others) and one or more output devices 224 (e.g., a CRT monitor, an LCD display panel, and/or a speaker, among others). Otherwise, user input may be received via a workstation 201 used by remote personnel to access the computer system 200 via the network 218, or via a dedicated workstation interface or the like.

Computer system 200 operates under the control of an operating system 230, and executes or otherwise relies upon various computer software applications 232, components, programs, objects, modules, data structures, etc. (e.g., database 234, among others). Moreover, various applications, components, programs, objects, modules, etc. may also execute on one or more processors in another computer coupled to computer system 200 via another network, e.g., in a distributed or client-server computing environment, whereby the processing required to implement the functions of a computer program may be allocated to multiple computers over the network.

Other hardware components may be incorporated into system 200, as may other software applications. In general, the routines executed to implement the embodiments of the invention, whether implemented as part of an operating system or a specific application, component, program, object, module or sequence of instructions, or even a subset thereof, will be referred to herein as “computer program code”, or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, magnetic tape, optical disks (e.g., CD-ROM's, DVD's, etc.), among others, and transmission type media such as digital and analog communication links.

Those skilled in the art will recognize that the exemplary environment illustrated in FIG. 2 is not intended to limit the present invention. Indeed, those skilled in the art will recognize that other alternative hardware and/or software environments may be used without departing from the scope of the invention.

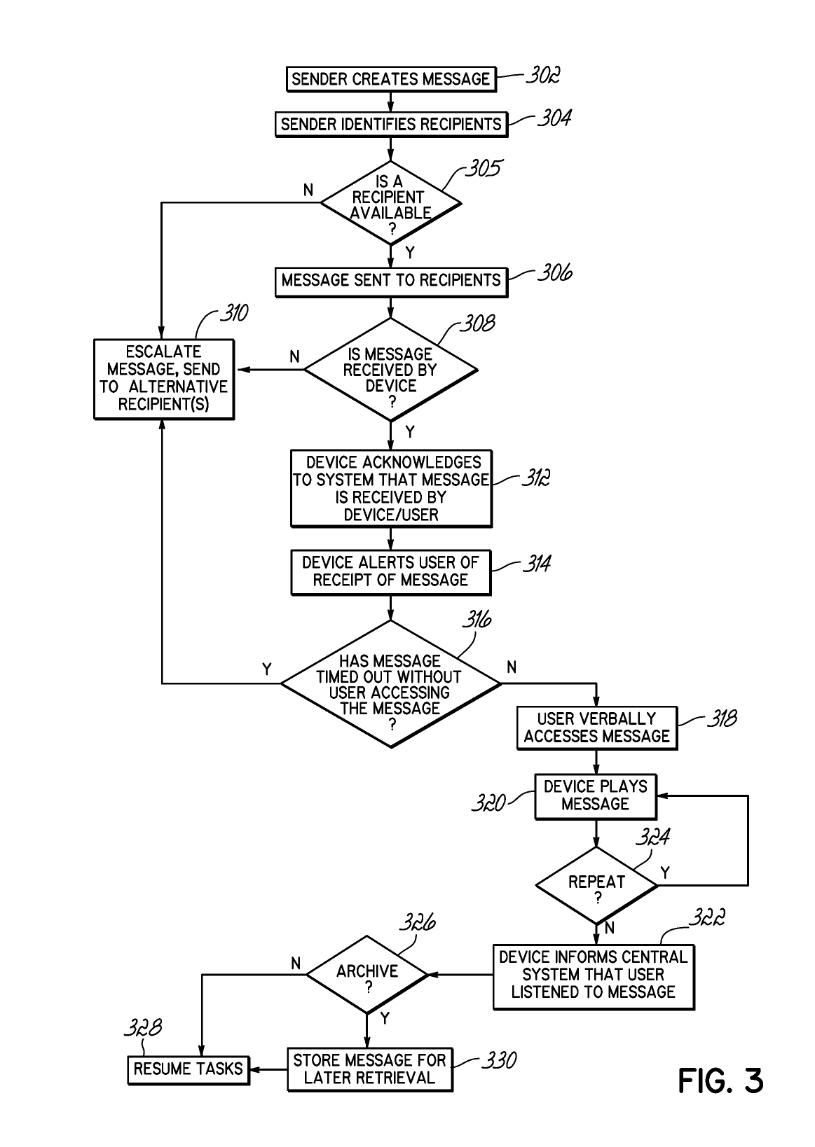

One particular software application 232 that resides on the system 200 is a messaging application that allows a user to enter a message, such as via a keyboard, to select one or more recipients to receive the message, to send the message to the recipients, and to track responses from the recipients. The flowchart of FIG. 3 depicts an exemplary method that can be implemented in such a software application.

In step 302, a sender creates a message, as facilitated by a messaging software application 232. One exemplary method of data entry involves typing in a text message via a keyboard or similar device. The text message is converted to an audible message and is played for the recipient. Alternatively, the message could be spoken and converted from speech to text or to some other electronic format, such as digitized speech, in preparation for delivery to a user. Additionally, a number of pre-defined message templates may exist from which a sender could select one to send to a group of users. A recorded voice message might also be created and saved by system 200 for sending to one or more recipients, like a voice mail. For example, a user 114-118 might record a message through a headset 107 and/or device 106 for being sent to one or more users.

In step 304, the sender identifies the recipients for the message or which users in the system are to receive the message. Alternatively, the sender identifies which users of a group to exclude from receiving the message. The recipients might be identified by name, or they might be associated with a particular context, such as a person assigned to an area or a person assigned to a particular work tool. In a healthcare context, the recipient might be the person (whoever that might be) assigned to a particular facility room or a person assigned to a particular facility resident or patient. For example, a resident in a room needing help or assistance may press a room buzzer. The central system knows the room number and would then select the recipient for the buzzer message (e.g., “Page from Room 25”). The selected recipient would be whoever is assigned to the room. Similar to composing e-mail messages in conventional e-mail programs, identifying the recipients and building the body of the message can take place in either order, or even concurrently. While a sender could type in the name of each recipient, the present invention advantageously contemplates using address groups or address books to simplify identifying the group of one or more recipients of the message. The address book can be organized by users or supervisors, by functional work units, by alphabet, and/or by a variety of other schema as would be recognized by one of ordinary skill. Or, as noted, the recipient might just be selected based on criteria (e.g. a message from Room 25).

In step 306, the software application converts the selected recipient names to appropriate network addresses and the message is sent to the recipients. As previously mentioned, the system 102, and specifically computer system 200, maintains an association table 233 of user/device network addresses for each user/device it can communicate with. For example, as part of activating a wireless device 106, 107, the system 102 and device may exchange initial messages to establish a viable communications link. System 102 also maintains the specific associations 132 of the devices and the users that are signed on to such devices. This exchanged information from each terminal can be maintained in a table 132 or other format by the system 102. This mapping may be static if the same device is always assigned to the same user. Alternatively, the mapping can be dynamically created when a user is given a device at the beginning of a work period and signs in or logs on with that device, or if a user must replace a faulty device during a work period. Using this mapping information 132, the system 102 can identify which network devices correspond to the list of recipients selected by the sender.

In some systems, the system may only allow a particular user to sign on to one of the network devices. In such a scenario, when a message is sent to that user, the system only has to send the message to one particular device. Alternatively, it may be possible for a user to sign on to the system with multiple devices. In that scenario, the system would maintain an association table for that particular user with each of the devices to which they log on or sign on. Then, the message is sent to each of those multiple devices that are associated with the user that is selected to receive a certain message.

After the message is sent, a delivery protocol can be used such that, in step 308, the system determines if the message is received by the recipient and the one or more devices to which it is sent. For example, the user device sends back an acknowledge message to inform the system 102 that the recipient's device received the message.

In accordance with one aspect of the present invention, if a recipient is not available, a message is not assigned to a particular recipient, or has not been received by a particular user or recipient, the message is escalated in is handling, and may be re-routed to one or more other users so that the message may be properly addressed. As shown in FIG. 3, in one example, such re-routing might be handled prior to actually sending the message (Step 305). For example, there may be particular task scenarios within the work environment that require the message to be properly delivered to a recipient. For example, it may be a particular task that must be performed soon after the message is delivered or within a particular time frame. As may be appreciated, the healthcare industry is one such area where a particular work task or process must be handled, and if there is no specific recipient available or designated for the task, the message must be re-routed to another user or group of users. Therefore, rather than the message being lost or dropped if the desired recipient is unavailable or recipient's device does not receive it, the message is escalated and directed to one or more other recipients/users.

As noted in U.S. Patent Application No. 61/087,082, entitled “Voice Assistant System”, filed on Aug. 7, 2008, in a healthcare environment, such as an assisted-living facility or other medical care facility, a message might be designated for a particular resident or patient, and directed to performing a particular care task. Generally, for such a patient or resident, a care provider, such as a nurse assistant, may be assigned to a room (Room 25, for example) where that patient/resident lives or is located. However, in certain scenarios, even though a message is designated for that room and the patient/resident, a user has not yet been assigned to that room or originated from a page from that room. Therefore, there may not be an available recipient for the message. The system determines, via step 305, if a recipient is available for the message. If a recipient is not available because a particular user has not been assigned to receive the particular message, or the assigned recipient has not signed onto their device in order to receive the message, the message is escalated through step 310. Pursuant to the escalation protocol, there is a list of one or more alternative recipients for the message. For example, the alternative recipients might include an entire group (e.g., the group for that area of a “facility”) for receiving the message, and thereby handling any work tasks associated with that message or otherwise handling the message. Therefore, in accordance with one aspect of the invention, the system 102 escalates the message to ensure that it is properly received and handled when a specific recipient is not available to receive the message. Alternatively, if one or more recipients are selected, the message is sent to the recipients, as noted above (step 306). However, the message still might not be received by the recipients for other reasons, and thus, will need to be escalated in that scenario as well.

For example, the recipients' device may not receive the message. The device of a selected user may not be turned on or may not be operating functionally. Alternatively, the user may be out of range of communication with the central system. Still further, an intended recipient may have switched devices during the message being sent and thus, would not be able to reply or respond to the message. In such a scenario, the selected device and assigned recipient would not receive the message and would not acknowledge receipt of the message to system 102 (step 308). If no acknowledgement is received by system 102 within a pre-determined time frame, then the system may attempt to re-send the message a number of times to the selected user/device. However, if the terminal is turned off or is out of range in the network, proper delivery and receipt of the message may not be possible for the selected user/device. If receipt of the message is never completed by the device, prior systems would “time out”, and the message might be lost.

In an alternative scenario, a particular selected recipient or user may not be signed in to one of the network devices to receive a message directed to them. Therefore, a message designated for “John Smith” could not be properly delivered, because John Smith has not signed into a device on the system, and thus, there is nowhere to send or no device to receive the message designated for John Smith. In such a scenario, a message might also be lost.

In those scenarios, the present system 102 escalates the message to ensure that is it properly received and handled (Step 310). Upon the system determining that the message has not been received by the recipient's device, either because the device is not operating, is out of range, or the selected recipient is not logged into a particular device of the network, the message is re-routed to one or more other recipients pursuant to the escalation protocol.

Escalation might be handled by one or more applications 130 as run by system 102. Pursuant to an escalation protocol, there may be a list of one or more alternative recipients for the message. As illustrated by step 310 in FIG. 3, the message is escalated and sent to the alternative recipient(s). For example, a group associated with a desired recipient might be designated to receive the escalated and re-routed message. Or a group associated with an area of a facility or work space might receive it. Alternatively, the supervisor of a particular user might receive the escalated message. Still further, other users, which can handle a task associated with the message, might receive the escalated message as part of the escalation protocol. To that end, in one embodiment of the invention, the escalation protocol may be specifically tailored to set one or more other recipients as recipients for escalated messages. In one possible embodiment, all of the other users in the network might receive the escalated message so that one or more of those users might be able to properly handle that message and any work or tasks associated therewith. Escalation might also be utilized to handle other messaging scenarios, as discussed below.

Referring again to FIG. 3, if the selected recipient is logged onto a network device and the message is properly received by that device pursuant to step 308, the device will generally acknowledge to the system that the message has been received by the device (step 312). In fact, as noted above, failure of that acknowledgement is often an indication of the fact that the message has not been properly received by a selected device or recipient, and should be escalated. Once the device acknowledges to the system that the message is received by the device, as in step 312, the user then must listen to the message, play the message, or otherwise access the message.

To that end, the device alerts the user of the receipt of the message as set forth in step 314. Such an alert might be handled in various different appropriate fashions. For example, the device might include one or more indicator lights that turn on or flash upon receipt of a message. Alternatively, in a voice-enabled system, the message alert or indication might be handled audibly. For example, as set forth in U.S. Patent Application No. 61/087,082, entitled “Voice Assistant System”, filed on Aug. 7, 2008, various message tones are used to indicate that a message has been received by the device for the user of that device. Usually, in a voice-enabled system, the user is engaged in a speech dialog back and forth with the device and system 102, such as to obtain work directions or information or to report the status of particular work tasks. As such, there are certain times that are not appropriate for playing a message. To that end, in one embodiment of the invention, the user has the ability to select an appropriate time for listening to the message. Therefore, delivery of the message to the terminal does not ensure that a user actually listens to the message. As noted below, system 102 is configured to track how a user responds to the message.

Generally, in voice-enabled environments, voice applications are executing on the wireless device and can involve a voice dialog and work flow sequence in conjunction with the activity of the user. Alternatively, a user might be within a voice-selectable menu associated with the work activity of that user. In response to receiving a message from the server and alerting the user, the user must then determine whether it is an appropriate time to interrupt the workflow process and access the message to hear it. If it is not appropriate to interrupt the workflow, the user may ignore the message. Visual indicators, such as flashing lights or repeated audible tones, continue to remind the user that they have a message that has not been accessed and listened to. To that end, system 102 and/or a device 106/107 might implement an application of some other software functionality that times out if the user indefinitely ignores the message by not accessing it and listening to the message. As noted in step 316 of FIG. 3, if the message is timed out without the user accessing that message, the message might be escalated and sent to alternative recipients (step 310). Thus, escalation might occur at various points in the message flow, as illustrated in FIG. 3 to ensure proper message delivery. Since the user may be performing some specific workflow activity that cannot be ignored for a message, the amount of time for a time out according to step 316 might be appropriately selected for a user/device, based upon the workflow that is handled. For emergency messages, a user might be given a shorter period of time to verbally access the message and listen to it. Alternatively, for less important messages, a longer amount of time might be given to the user.

At the appropriate time, the user may verbally access the message, as shown in step 318. The device will then audibly play the message per step 320. Verbal access may be provided in a number of ways. For example, in some voice-enabled systems, speech is used constantly to direct the user to perform specific tasks. Therefore, an ongoing speech dialog is maintained on a somewhat regular basis. When a message is received, the device might speak and say, “You have a message”. The user would then speak a command such as “Continue” or “Yes” or “No” to verbally access the message. The device would then play the message upon receiving and recognizing the proper spoken command. If “No” is spoken, the device 106/107 will continue to notify the user each time that the device speaks part of its dialog. Therefore, if the user says “No” and continues with providing spoken information to the device which is then recognized through a speech-recognition application and used as part of the dialog, the message is postponed. However, when the device is then ready to again speak back to the user and provide its portion of the dialog, it may again repeat, “You have a message”. Alternatively, the recipient may not be given a choice to ignore the message. That is, the recipient may be forced to listen to the message if they want to continue with their work dialog. Therefore, they must speak the proper command or words to listen to the message, or the voice-enabled system will not proceed further.

In alternative embodiments, where speech is less intrusive into the workflow, the device 106/107 would give the user greater flexibility in selecting an appropriate time to access the message and listen to it. To that end, audible tones might be played periodically, but the reminders will be less disruptive and annoying to the user. For example, reminder tones might be played every minute until the message is verbally accessed by the user. In that way, the user is reminded, even though there may not be an ongoing voice dialog. Upon deciding to listen to the message, the user might return to a particular menu, such as the main menu, and give a verbal command to listen to the message (e.g. “Review page” or “Review message”). The speech recognition capability of the device is used to recognize the user's commands for listening to or otherwise handling a message.

As such, the present invention provides escalation and a change in the routing of a communication message based on certain working conditions or changes in work flow or priority. For example, the availability of a particular recipient, the work tasks to be performed, the change of status of a recipient in the system, the lack of ability to connect with a recipient's device, some event happening or not happening etc., may all dictate the escalation protocol. Depending on work context, escalations of the message or other communication may produce a routing of the communication to various named persons, a particular person in a work-related role, a workgroup or up some other hierarchy for the message and work place. Various triggers may be used for escalation as noted above including unavailability of a recipient, failure to connect to a particular recipient and/or device and a time-out or elapsed time without acting on the message or some other resolution.

Once accessed by the user, the message might be opened and played by the device 106/107 as audio output to a headset or other speaker. For example, a text message would be converted to speech via the text-to-speech capability of the device. Generally, speech recognition and text-to-speech applications are combined in a voice-enabled device. Alternatively, if the message was a live voice recording, it might be replayed to the user.

When the message has been played to the user, the device informs system 102 that the user has listened to the message, or rather that the message has been played to the user (step 322).

In accordance with another aspect of the invention, the message might be further processed by the user. For example, as illustrated in FIG. 3 as step 324, the device 106/107 might give the user the opportunity to repeat the message. For example, if the user has listened to the message, they might speak the command, “Repeat”. In an alternative system, the device may actually ask the user a question such as “Do you want to hear again—Yes or No?” Based upon either the command or the answer given by the user, the device may again play the message (step 320). In that way, the present invention ensures that the message is properly heard and understood by a user.

In some systems, once the message is played and is not repeated, the message is gone or erased from the system. In accordance with one aspect of the present invention, the message might be further handled by being stored or archived for future listening. Referring to step 326 in FIG. 3, a user might be prompted by the device 106/107 or the system 102 as to whether they wish to archive the message that they just listened to. If they do not want the message archived, for example, they answer “No”. The messaging is complete, and the user would then resume their work-related tasks pursuant to the speech-enabled system (step 328). If the user answers the archived inquiry affirmatively or possibly speaks a command “archive”, the message would be stored for later retrieval (step 330). Then, the user would proceed with their work tasks (step 328).

Archiving may be desirable for certain messages. For example, a message might be somewhat lengthy and may involve a significant amount of information that would have to be remembered by the user. They may listen to the message to initially find out its purpose and content, but then may decide to handle the message at a later time. So that the information in the message is not forgotten, the user might then retrieve the archived message and play it again. Such retrieval might be implemented through a voice command such as “retrieve archived messages” and therefore, played back at the user's convenience. Alternatively, certain messages may be so long that it is necessary to play them again even if the user decides to execute a particular work task associated with the message shortly after listening to the message. For example, it may take some time for them to get to a location, or access equipment. Therefore, they may want to repeat the archived message to ensure the message is properly addressed.

In still another alternative, a user might receive multiple messages that they then have to address in sequence, such as by performing certain tasks in a sequence. The user may then have to determine what the most appropriate sequence is and thus, would archive the messages so that they can later be retrieved in the order decided upon by the user.

The present invention may be utilized to improve time efficiency for users/workers, and to also provide an overall management and supervision for workers apart from the specific tasks associated with their current workflow process. Furthermore, the invention provides the ability to handle emergencies and to re-route important messages that are not received or listened to by the desired user(s)/recipient(s).

In the system 102, an audit trail is created that shows if a user/device received the message. Furthermore, the audit trail permits tracking of whether the user listened to the message.

The invention, through escalation, determines alternate means for message delivery for those situations when the message must be delivered and heard by someone. Furthermore, messages may be archived for purposes of re-listening to the message.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. Thus, the invention in its broader aspects is therefore not limited to the specific details, representative apparatus and method, and illustrative example shown and described. Accordingly, departures may be made from such details without departing from the spirit or scope of applicants' general inventive concept.

What is claimed is:

1. A method for sending messages in a voice-enabled system, comprising:
generating a message with a message generating device;
analyzing the message to determine a voice-enabled device to send the message to;
determining whether the voice-enabled device is available to receive the message;
in response to determining that the voice-enabled device is available to receive the message, sending the message to the voice-enabled device; and
in response to determining that the voice-enabled device is not available, escalating the message based on an escalation protocol.

2. The method of claim 1, wherein analyzing the message further comprises:
determining, from data associated with the message, that the voice-enabled device is a recipient for the message.

3. The method of claim 1, wherein analyzing the message further comprises:
determining, from data associated with the message, an identifier associated with the message generating device; and
determining that the voice-enabled device is a recipient for the message based on the identifier.

4. The method of claim 3, wherein determining that the voice-enabled device is the recipient for the message based on the identifier further comprises:
accessing a table; and
determining that the voice-enabled device is the recipient for the message based on the identifier and data stored in the table.

5. The method of claim 1, wherein determining whether the voice-enabled device is available to receive the message further comprises:
querying the voice-enabled device to determine whether the voice-enabled device is available.

6. The method of claim 5, further comprising:
receiving a response to the query that indicates the voice-enabled device is available to receive the message.

7. The method of claim 1, wherein determining whether the voice-enabled device is available to receive the message further comprises:
accessing a table indicating all voice-enabled devices that are available to receive the message.

8. The method of claim 1, wherein escalating the message further comprises:
determining whether a second voice-enabled device is available to receive the message.

9. The method of claim 1, wherein escalating the message further comprises:
sending the message to a second voice-enabled device.

10. The method of claim 1, further comprising:
determining whether the voice-enabled device received the message; and
in response to determining that the voice-enabled device did not receive the message, escalating the message to a second voice-enabled device based on the escalation protocol.

11. The method of claim 1, further comprising:
determining whether the voice-enabled device has accessed the message within a predetermined amount of time; and
in response to determining that the voice-enabled device has not accessed the message within the predetermined amount of time, escalating the message based on the escalation protocol.

12. The method of claim 1, further comprising:
receiving an indication that a user of the voice-enabled device has accessed the message.

13. The method of claim 12, further comprising:
analyzing the indication to determine whether to archive the message; and
in response to determining to archive the message, archiving the message in a memory of a computing system.

14. The method of claim 13, further comprising:
analyzing the indication to determine an order for the message; and
in response to a request for at least one archived message from the voice-enabled device, providing the message according to the order.

15. The method of claim 12, further comprising:
storing data indicating that a user of the voice-enabled device has accessed the message.

16. The method of claim 1, further comprising:
storing data indicating that the voice-enabled device has been sent the message.

17. The method of claim 1, wherein the escalation protocol is a list of one or more alternative voice-enabled devices for the message.

18. The method of claim 1, further comprising:
capturing speech input with the message generating device to include in the message.

19. The method of claim 1, further comprising:
capturing data identifying the voice-enabled device as a recipient of the message with the message generating device to include in the message.

20. The method of claim 1, further comprising:
receiving an indication that the voice-enabled device has received the message.

21. The method of claim 1, further comprising:
receiving an indication that the message has not been accessed within a predetermined amount of time by a user of the voice-enabled device.

22. The method of claim 1, wherein the message includes speech input captured from a user associated with the message generating device.

23. The method of claim 1, wherein the message includes text input captured from a user associated with the message generating device.

24. The method of claim 1, wherein the message generating device is a computing system that executes a messaging software application.

25. The method of claim 1, wherein the message generating device is a second voice-enabled device.

26. A voice-enabled system to communicate a message, comprising:
a message generating component configured to generate a message; and
a computing system configured to analyze the message to determine a voice-enabled device to which to send the message, and determine whether the voice-enabled device is available to receive the message,
the computing system further configured to send the message to the voice-enabled device in response to determining that the voice-enabled device is available to receive the message and escalate the message based on an escalation protocol in response to determining that the voice-enabled device is not available to receive the message.

27. The system of claim 26, wherein the computing system is further configured to determine that the voice-enabled device is a recipient for the message from data associated with the message.

28. The system of claim 26, wherein the computing system is further configured to determine an identifier associated with the message generating component from data associated with the message and determine that the voice-enabled device is a recipient for the message based on that identifier.

29. The system of claim 28, wherein the computing system is further configured to access a table and determine that the voice-enabled device is a recipient for the message based on the identifier and data stored in the table.

30. The system of claim 26, wherein the computing system is further configured to query the voice-enabled device to determine whether the voice-enabled device is available.

31. The system of claim 30, wherein the computing system is further configured to receive a response to the query that indicates the voice-enabled device is available to receive the message.

32. The system of claim 26, wherein the computing system is further configured to access a table indicating all voice-enabled devices that are available to receive the message to determine whether the voice-enabled device is available.

33. The system of claim 26, wherein the computing system is further configured to determine whether a second voice-enabled device is available to receive the message in response to escalating the message.

34. The system of claim 26, wherein the computing system is further configured to send the message to a second voice-enabled device in response to escalating the message.

35. The system of claim 26, wherein the computing system is further configured to determine whether the voice-enabled device received the message and escalate the message based on the escalation protocol in response to determining that the voice-enabled device did not receive the message.

36. The system of claim 26, wherein the computing system is further configured to determine whether the voice-enabled device has accessed the message within a predetermined amount of time and escalate the message based on the escalation protocol in response to determining that the voice-enabled device has not accessed the message within the predetermined amount of time.

37. The system of claim 26, wherein the computing system is further configured to receive an indication that the second voice-enabled device has accessed the message.

38. The system of claim 37, wherein the computing system further comprises:
a memory, and
wherein the computing system is further configured to analyze the indication to determine whether to archive the message and archive the message in the memory in response to determining to archive the message.

39. The system of claim 38, wherein the computing system is further configured to analyze the indication to determine an order for the message and provide the message according to the order in response to a request for at least one archived message from the voice-enabled device.

40. The system of claim 37, wherein the computing system is further configured to store an indication that the voice-enabled device has accessed the message.

41. The system of claim 26, wherein the computing system is further configured to store an indication that the voice-enabled device has been sent the message.

42. The system of claim 26, wherein the escalation protocol is a list of one or more alternative voice-enabled devices for the message.

43. The system of claim 26, wherein the message generating component is further configured to capture speech input to include in the message.

44. The system of claim 26, wherein the message generating component is further configured to capture data identifying the voice-enabled device as a recipient of the message.

45. The system of claim 26, wherein the computing system is further configured to receive an indication that the voice-enabled device has received the message.

46. The system of claim 26, wherein the computing system is further configured to receive an indication that the message has not been accessed within a predetermined amount of time by a user of the voice-enabled device.

47. The method of claim 26, wherein the message includes speech input captured from a user associated with the message generating device.

48. The method of claim 26, wherein the message includes text input captured from a user associated with the message generating device.

49. The system of claim 26, wherein the message generating component is a messaging software application executed by the computing system.

50. The system of claim 26, wherein the message generating component is a second voice-enabled device.
